(19) United States
(12) Patent Application Publication
(10) Pub. No.: US 2009/0084275 A1
(43) Pub. Date: Apr. 2, 2009

(54) Juicer with improved structure

(75) Inventor: Kai-Fu Liang, Taipei (TW)

Correspondence Address: Chen Pin Business Co., Ltd., P.O.Box 166-13, Taipei, 115, TW

(73) Assignee: Chen Pin Business Co., Ltd.

(21) Appl. No.: 12/222,246

(22) Filed: Aug. 6, 2008

(30) Foreign Application Priority Data
Sep. 28, 2007 (TW) 096216185

(51) Int. Cl. A23N 1/02; A47J 43/046

(52) U.S. Cl. 99/513; 366/205; 241/279

(57) ABSTRACT

A length of a duct (42) can be altered added to a filter mask (4) mounted inside a container (2). Further the filter mask joins to the container by clasping and joining together ribs, which are easy to maintain for cleaning purpose. In detail, a duct (42) is mainly composed of a wheel spacer (42a) as a low profile “mount base”; and an extension tube (42b) can be assembled to or detached from said wheel spacer (42a) as demanded. A bottom rim of the filter mask (4) has a plurality of L-shaped ribs (44) disposed therearound. Ribs (44) corresponding to a plurality of transverse ribs (21) projected inward inside a bottom of said container (2) can clasp and join together with the ribs (21) respectively. Thus, the filter mask (4) mounted inside the container (2) can be avoided from relaxing hold on each other.

### FIELD OF THE INVENTION

The present invention is related to an improved structure of a juicer; particularly to a filtering mask inside the container to pulverize fibers more subtly.

### GROUND OF THE INVENTION

Usually, blades disposed inside a container of juicer can be rotated rapidly to slice and mix the fresh-cut fruits. Pulps and fibers contained in the juice shows a thick, pasty mixture. Clinging fibers remain partly stretched lengths substantially strangled with coarse syrup of so-called fruit grains. To shove juice into mouth is not to be melt further not easily to swallow it. A filter mask may be added inside the container to cover up the blades. Fresh-cut fruits sliced, mixed inside the filter mask for a longer while, the processed fibers and coarse fruit grains taste more soft and subtle, and then filtrated through the filter mask flows into the container.

In the prior arts, as shown in FIG. 9, L-shaped ribs (2B), for clasping and joining transverse ribs, are formed inside a bottom of the container hidden with dead space (C), that is not easy to clean. In FIGS. 10A and 10B, flow deflectors are shaped with right angled triangular profiles, with a vertical leading edge and an inclined trailing edge. When the juicer is rotated clockwise, water flow impacts the trailing edge, juice in the bottom level may rise upward. While the juicer is rotated counterclockwise, water flow impacts the leading edge, it may be formed as turbulent flow.

Or as U.S. Pat. No. 6,725,763 entitled “Device and method for making coffee and espresso drinks” to Cai, Edward Z on Apr. 27, 2004 (hereafter Cai), in FIGS. 6a and 6c, Cai depicted a bottom plate can be opened manually or thermally controllable so that ground coffee in a storage chamber can be mixed with liquid; or a blade connected to a motor grinds and mixes flavor containing materials with liquid. Other than FIGS. 6a and 6c, to increase the flow rate of the beverage through porous filter by shaking or repetitively tilting the container, or pouring hot water onto the porous filter is requested by Cai for reducing the amount of the flavor-containing materials may pass through the quasi filtration openings, thus preventing any measurable deterioration in beverage quality or taste.

Or as U.S. Pat. No. 6,135,019 entitled “Filter assembly for a blender” to Shang-Wei Chou on Oct. 24, 2000 (hereafter Chou), it disclosed “a filter member positioned within the container of the blender and surrounds the blade member located at the base of the container. Fruit juice from the fruit pieces is allowed to flow through perforations on the filter member from a pulp compartment to a juice compartment while pulps are retained within the pulp compartment and the fruit juice can be poured out from an off-centered spout of a main cap member to be consumed without pulps.”

As known, both patented cases as mentioned above are not kept in force, it means that the juicer still can be improved with a filter mask mounted inside the container.

### SUMMARY OF THE INVENTION

The present invention is to provide a juicer has an improved structure, that is characteristic of a length of a duct can be altered, said duct is designed to connect to a filter mask mounted inside a container, further the filter mask joins to the container by clasping and joining together ribs, which are easy to maintain for cleaning purpose, also flow deflectors disposed inside the container can be used to avoid turbulent flow either the juicer is rotated clockwise or counterclockwise.

A juicer with an improved structure comprises a base (1) has a motor (11), a container (2) mounted on the base (1), a cutter blade (3) disposed inside the container (2) is connected to the motor (11), a filter mask (4) fit inside the container (2) encloses the cutter blade (3), and a cup (5); a filtration net (41) wraps around said filter mask (4), a duct (42) joined to the filter mask (4) is extended straight upward toward the cup (5); a diameter of said duct (42) is smaller than the filter mask (4), and the duct (42) is in communication with the filter mask (4) characterized in that: the duct (42) includes a wheel spacer (42a) on top of the filter mask (4) and projected upward, a removable extension tube (42b) assembled to the wheel spacer (42a).

The juicer with an improved structure wherein an opening of said wheel spacer (42a) is formed with inner threads (421) screwed to outer threads (431) at a bottom end of said extension tube (42b).

The juicer with an improved structure wherein a top end of said wheel spacer (42a) is formed with outer threads screwed to inner threads at a bottom end of said extension tube (42b).

The juicer with an improved structure wherein perforations (422, 424) formed through walls of said wheel spacer (42a) and said extension tube (42b) respectively for liquid dispersion.

The juicer with an improved structure wherein a bottom rim of said filter mask (4) has a plurality of L-shaped ribs (44) to clasp a plurality of transverse ribs (21) projected inward from inside of a bottom of said container (2).

The juicer with an improved structure wherein a plurality of flow deflectors (22) disposed inside a bottom of the container (2) are distributed around a center of the bottom of container (2) to facilitate juice flow circumvents said center.

An alternate embodiment of a juicer with an improved structure comprises a base (1) has a motor (11), a container (2) mounted on the base (1), a cutter blade (3) disposed inside the container (2) is connected to the motor (11), a filter mask (4) fit inside the container (2) encloses the cutter blade (3), and a cup (5); a filtration net (41) wraps around said filter mask (4), a duct (42) joined to the filter mask (4) is extended straight upward toward the cup (5); the duct (42) is in communication with the filter mask (4) characterized in that: a bottom rim of said filter mask (4) has a plurality of L-shaped ribs (44) to clasp a plurality of transverse ribs (21) projected inward from inside of a bottom of said container (2); a gap between said transverse ribs (21) and the bottom is larger than a breadth of said L-shaped ribs (44).

### ADVANTAGES OF EMBODIMENTS OF THE INVENTION

The present invention is characteristic of the merits as following:

1. Said extension tube (42b) assembled to said wheel spacer (42a) by screwing to form said duct (42). The extension tube (42b) can be joined to or detached from said wheel spacer (42a) as desired. Further, an opening of said wheel spacer (42a) is likely a low profile “mount base”, when the quantity of juice demanded is a scanty drink, only a small amount of water added to the container (2), fibers and fruit grains contained in the juice can be urged to swirl around by a centrifugal force to full-fill the opening of said wheel spacer (42a) and overflow into the filter mask (4) to facilitate flowing juice back to the opening to be sliced and pulverized again. But when the quantity of juice demanded is a free drink with great capacity, the extension tube (42b) assembled to the wheel spacer (42a), the container (2) can be filled with liquid, juice whirlpool over an opening of the extension tube (42b) into the filter mask (4) to facilitate flowing juice back to the opening of the extension tube (42b) to be sliced and pulverized again. Therefore, whether the extension tube (42b) necessitates being assembled to the wheel spacer (42a) see the quantity of juice demanded by users is a scanty drink or a free drink.

2. Perforations (422) formed through walls of said wheel spacer (42a) and extension tube (42b) can flow juice to the filter mask, before the juice full-fills the openings.

3. L-shaped ribs (44) of said filter mask (4) are used to clasp said transverse ribs (21), since the transverse ribs (21) are extended straight inward without any dead angle for cleaning purpose. Thus the container (2) is easy to clean out by water without any fibers strangled on the transverse ribs (21).

4. Flow deflectors (22) are projected upward on the bottom of the container having a generally truncated isosceles triangular profile; both leading edge and trailing edge of the flow deflectors (22) are inclined surfaces. Either the juicer is rotated clockwise or counterclockwise, juice flows to the flow deflectors (22) can swirl around and upward at an inclined angle, no turbulent flow will be generated.

### BRIEF DESCRIPTION OF DRAWINGS

FIG. 1: is an exploded view of the juicer of the invention;

FIG. 2: is an assembled view of FIG. 1;

FIG. 3: is an exploded view of the filter mask of the juicer of the invention;

FIG. 4: is a plan view of the extension tube of the invention with perforations formed through a wall of the extension tube;

FIG. 5: is a schematic view of the filter mask assembled with the wheel spacer only;

FIG. 6: is a schematic view of the filter mask assembled with the wheel spacer and the extension tube;

FIG. 7: is an enlarged view of the filter mask joined to the container by clasping and joining together ribs; and

FIG. 8A˜8B: are schematic views of flow deflectors inside the bottom of said container.

FIG. 9: is a perspective view of L-shaped ribs inside a bottom of the container of prior arts.

FIGS. 10A˜10B: are sectional views of profiles of flow deflectors of the prior arts.

### DETAILED DESCRIPTION OF THE PREFERRED EMBODIMENTS OF THE INVENTION

The description is described in detail according to the appended drawings hereinafter.

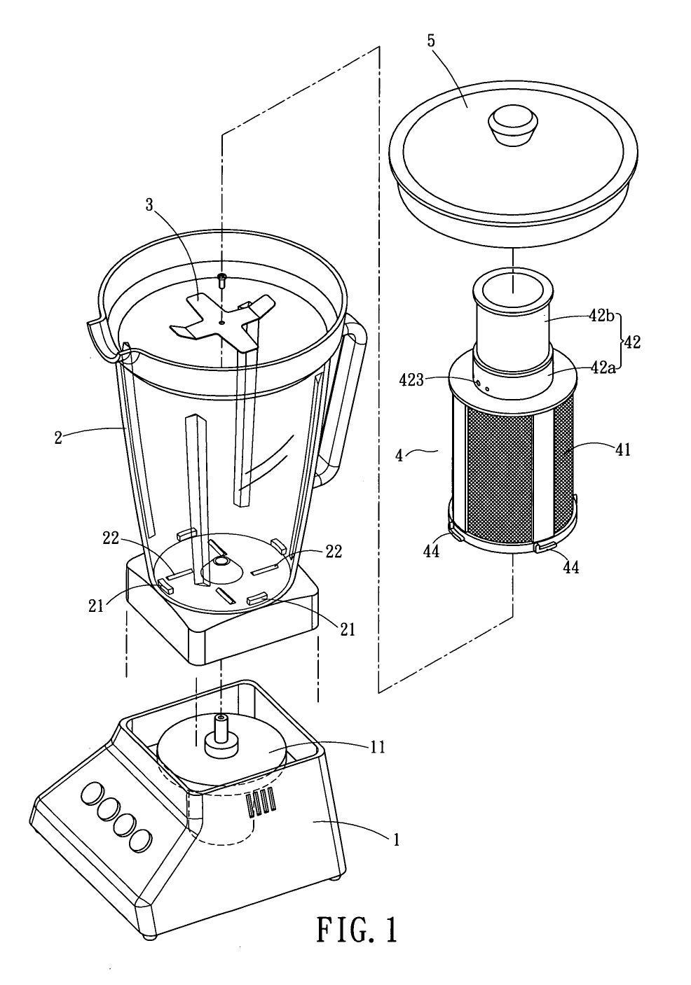

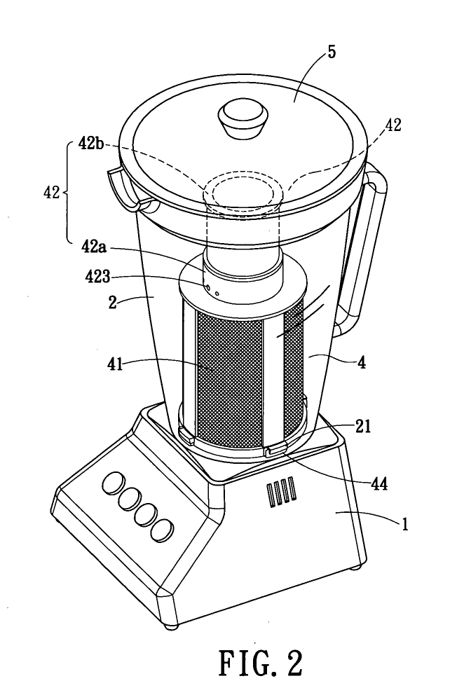

As shown in FIGS. 1˜4, the juicer includes a base (1) has a motor (11) mounted thereinside; a container (2) is assembled to the base (1), a cutter blade (3) disposed inside the container (2) is connected to the motor (11), a filter mask (4) fit inside the container (2) wraps around the cutter blade (3); and a cup (5); a filtration net (41) wraps around said filter mask (4), a duct (42) joined to the filter mask (4) is extended straight upward toward the cup (5); the duct (42) is in communication with the filter mask (4). A diameter of the duct (42) is smaller than the filter mask (4). Fresh-cut fruits can be fed through the feed chute or duct (42) into the filter mask (4), the cutter blade (3) driven by the motor (11) can further slice and pulverize the fresh-cut fruits. Subtle fibers can be expelled out of the filter mask (4), but fibers and coarse fruit grains left inside the filter mask (4) are continually pulverized. Mixtures of fibers and coarse fruit grains contained in the juice retained inside the container (2) therefore become more subtle and soft. However, the juice is necessarily diluted with water; otherwise, a thick pasty juice may delay pulverizing work.

Said duct (42) is integrally assembled to the filter mask (4), the duct (42) is mainly composed of a wheel spacer (42a) as a low profile “mount base”; and an extension tube (42b) can be assembled to or detached from said wheel spacer (42a) as demanded. An opening at a top end of said wheel spacer (42a) is formed with inner threads (421), while an opening at a bottom end of said extension tube (42b) is formed with outer threads (431). Or, the opening at the top end of said wheel spacer (42a) is formed with outer threads, while the opening at the bottom end of said extension tube (42b) is formed with inner threads. Thus, the extension tube (42b) can be assembled to or detached from the wheel spacer (42a) by screwing clockwise or counterclockwise.

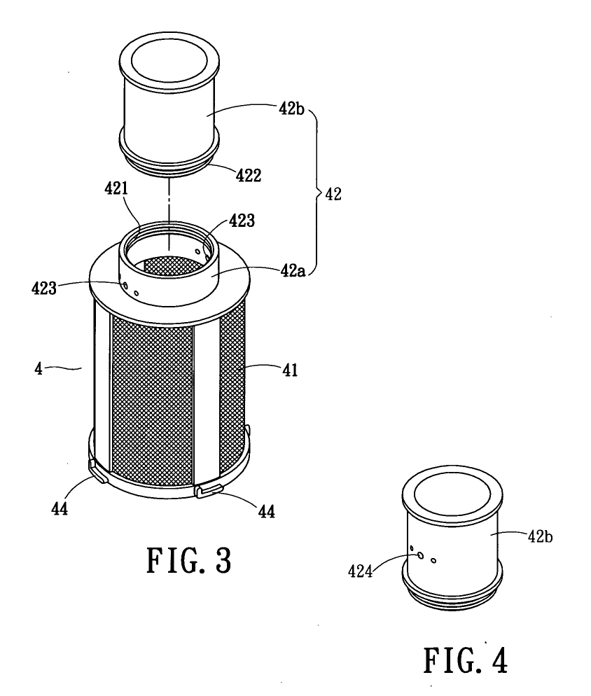

As shown in FIG. 3, several perforations (423) are formed through a wall of said wheel spacer (42a) for liquid dispersion into the filter mask (4). By centrifugal force, before juice swirls around and upward toward the opening at the top end of said wheel spacer (42a), liquid dispersion into the filter mask (4) can supplement sufficient liquid for the filter mask (4) filled with a whirlpool like blended mixture and juice. By the same reasoning, as shown in FIG. 4, several perforations (424) are formed through a wall of said extension tube (42b) for liquid dispersion. By centrifugal force, before juice swirls around and upward toward the opening at the top end of said extension tube (42b), liquid dispersion into the filter mask (4) can supplement sufficient liquid for the filter mask (4) filled with a whirlpool like blended mixture and juice.

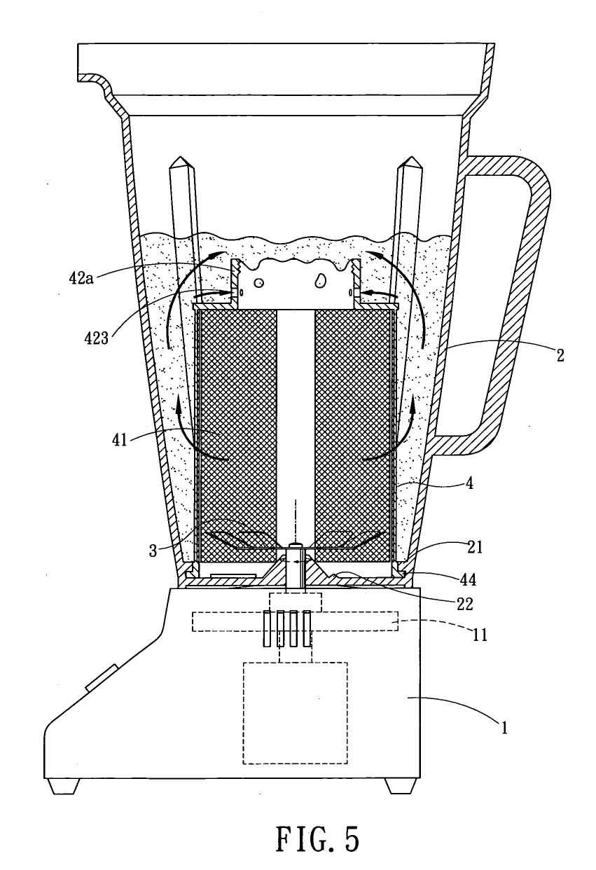

As shown in FIG. 5, a schematic view of the filter mask assembled with the wheel spacer is illustrated. The top opening of said wheel spacer (42a) is likely a low profile “mount base” for whether receiving the extension tube (42b) therein or not, when the quantity of juice demanded is a scanty drink, only a small amount of water added to the container (2), fibers and fruit grains contained in the juice can be urged to swirl around by a centrifugal force to full-fill the opening of said wheel spacer (42a) and overflow into the filter mask (4) to facilitate flowing juice back to the opening to be sliced and pulverized again.

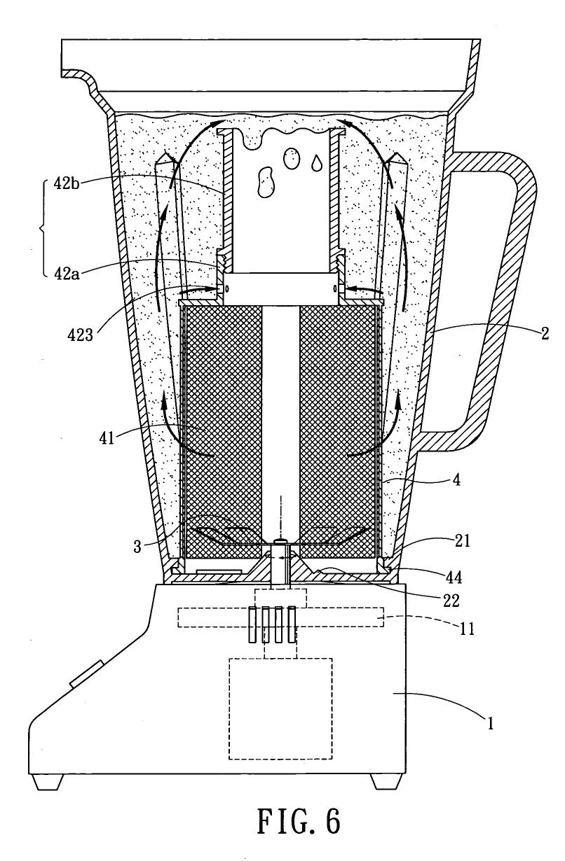

As shown in FIG. 6, a schematic view of the filter mask assembled with the wheel spacer and the extension tube is illustrated. Said extension tube (42b) is necessarily assembled to said wheel spacer (42a), when the quantity of juice demanded is a free drink with great capacity. As the extension tube (42b) assembled to the wheel spacer (42a), so the container (2) can be filled with liquid, juice whirlpool over an opening of the extension tube (42b) into the filter mask (4) to facilitate flowing juice back to the opening of the extension tube (42b) to be sliced and pulverized again.

Therefore, whether the extension tube (42b) necessitates being assembled to the wheel spacer (42a) see the quantity of juice demanded by users is a scanty drink or a free drink.

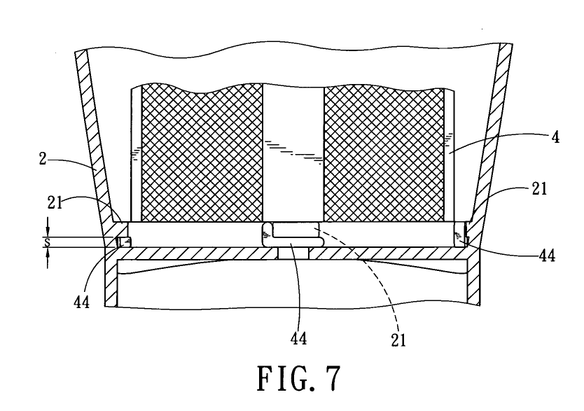

As shown in FIG. 7, an enlarged view of the filter mask joined to the container by clasping and joining together ribs is illustrated. In FIGS. 1 and 7, a bottom rim of the filter mask (4) has a plurality of L-shaped ribs (44) disposed therearound. Those ribs (44) are corresponding to a plurality of transverse ribs (21) projected inward inside a bottom of said container (2). Each of ribs (44) can clasp and join together with one of the ribs (21) respectively. Thus, the filter mask (4) mounted inside the container (2) can be avoided from relaxing hold on each other. Furthermore, since the transverse ribs (21) are extended straight inward without any dead angle for cleaning purpose. Thus the container (2) is easy to clean out by water without any fibers strangled on the transverse ribs (21).

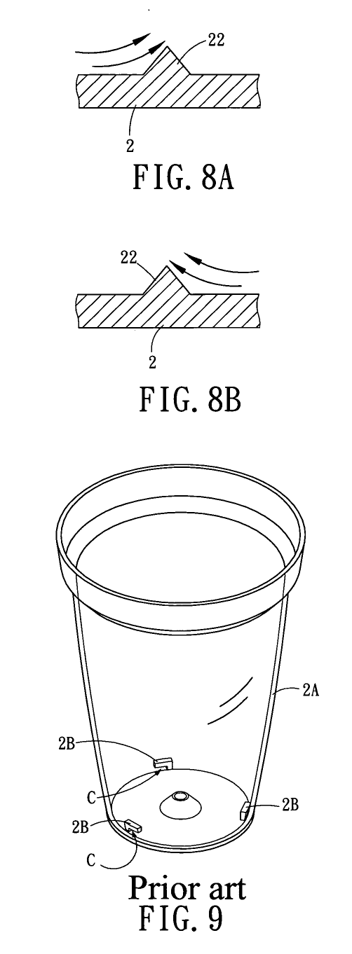

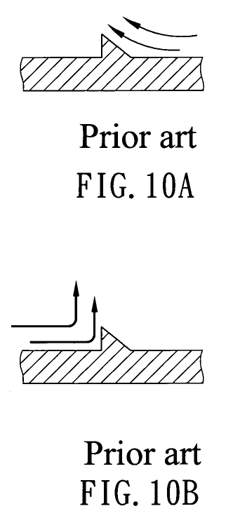

As shown in FIGS. 8A˜8B, schematic views of flow deflectors inside the bottom of said container are illustrated. Also see FIG. 1, inside the bottom of the container (2), a plurality of flow deflectors (22) are disposed therein. Flow deflectors (22) are substantially projected upward on the bottom of the container having a generally truncated isosceles triangular profile; both leading edge and trailing edge of the flow deflectors (22) are inclined surfaces. Either the juicer is rotated clockwise or counterclockwise, juice flows to the flow deflectors (22) can swirl around and upward at an inclined angle, no turbulent flow will be generated. Said flow deflectors (22) are distributed over the bottom of the container (2) along tangent lines on said cutter blade (3) so as to deflect flow to circumvent a central projection inside the container.

The cutter blade (3) can be rotated either clockwise or counterclockwise, juice flows to the flow deflectors (22) can swirl around and upward at an inclined angle by the generally truncated isosceles triangular profile, juice flows at a bottom level can be flown upward, there is no dead angle to the bottom level of juice on the bottom of the container.

What is claimed is:

1. A juicer with an improved structure comprises a base (1) has a motor (11), a container (2) mounted on the base (1), a cutter blade (3) disposed inside the container (2) is connected to the motor (11), a filter mask (4) fit inside the container (2) encloses the cutter blade (3), and a cup (5); a filtration net (41) wraps around said filter mask (4), a duct (42) joined to the filter mask (4) is extended straight upward toward the cup (5); a diameter of said duct (42) is smaller than the filter mask (4), and the duct (42) is in communication with the filter mask (4) characterized in that: the duct (42) includes a wheel spacer (42a) on top of the filter mask (4) and projected upward, a removable extension tube (42b) assembled to the wheel spacer (42a).

2. The juicer with an improved structure of claim 1 wherein an opening of said wheel spacer (42a) is formed with inner threads (421) screwed to outer threads (431) at a bottom end of said extension tube (42b).

3. The juicer with an improved structure of claim 1 wherein a top end of said wheel spacer (42a) is formed with outer threads screwed to inner threads at a bottom end of said extension tube (42b).

4. The juicer with an improved structure of claim 1 wherein perforations (422, 424) formed through walls of said wheel spacer (42a) and said extension tube (42b) respectively for liquid dispersion.

5. The juicer with an improved structure of claim 1 wherein a bottom rim of said filter mask (4) has a plurality of L-shaped ribs (44) to clasp a plurality of transverse ribs (21) projected inward from inside of a bottom of said container (2).

6. The juicer with an improved structure of claim 1 wherein a plurality of flow deflectors (22) disposed inside a bottom of the container (2) are distributed around a center of the bottom of container (2) to facilitate juice flow circumvents said center.

7. A juicer with an improved structure comprises a base (1) has a motor (11), a container (2) mounted on the base (1), a cutter blade (3) disposed inside the container (2) is connected to the motor (11), a filter mask (4) fit inside the container (2) encloses the cutter blade (3), and a cup (5); a filtration net (41) wraps around said filter mask (4), a duct (42) joined to the filter mask (4) is extended straight upward toward the cup (5); the duct (42) is in communication with the filter mask (4) characterized in that: a bottom rim of said filter mask (4) has a plurality of L-shaped ribs (44) to clasp a plurality of transverse ribs (21) projected inward from inside of a bottom of said container (2); a gap between said transverse ribs (21) and the bottom is larger than a breadth of said L-shaped ribs (44).
